(19) United States
(12) Patent Application Publication
(10) Pub. No.: US 2008/0024862 A1
(43) Pub. Date: Jan. 31, 2008

(54) Rear projection display system

(75) Inventor: Huang Kuo-Tsung, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/878,733

(22) Filed: Jul. 26, 2007

(30) Foreign Application Priority Data
Jul. 26, 2006 (TW) 095127226

(51) Int. Cl. G03B 21/10; G03B 21/56

(52) U.S. Cl. 359/460

(57) ABSTRACT

The invention provides a rear projection display system which includes a casing, a screen, a processing module, and a plurality of micro-projectors. The screen is mounted on the casing to form a space. The processing module is disposed in the space for receiving an input image. The micro-projectors are disposed in the space, arranged in a form of an array, and respectively electrically connected to the processing module. The micro-projectors are controlled by the processing module to project an array of overlapped sub-images onto the screen. The overlapped sub-images are generated according to the input image. The processing module corrects the misalignment of the overlapped sub-images to be projected, and further synthesizes the overlapped sub-images as the input image on the screen by use of the micro-projectors.

### BACKGROUND OF THE INVENTION

1. Field of the Invention

The present invention relates to a rear projection display system, and more particularly, relates to a rear projection display system with thin-sized characteristic and high resolution.

2. Description of the Prior Art

Rear projection display technique is to project the image generated by a small imager through an optical lens onto a screen. Compared with liquid crystal display technique, plasma display technique, and so on, it has the advantages of low price, low energy consumption, and high resolution. However, as shown in FIG. 1A which is a sketch diagram illustrating a conventional rear projection display system, for the optic configuration of the current rear projection display, either cathode ray tube projection display or microdisplay projection display, because the projection size of a single optical engine is larger and the projection distance is longer, it still has a thickness relatively not very thin even with one reflection. As shown in FIG. 1B which is a sketch diagram illustrating a currently used rear projection display system, the rear projection display system has a technique of aspherical lens and aspherical reflector with multi-reflection to achieve the thinner purpose, but neither the high price nor the bigger base of the screen is conducive to the market and acceptable to consumers.

Accordingly, a scope of the invention is to provide a rear projection display system capable of projecting by use of the combination of micro-projectors, so as to solve the problem mentioned above.

### SUMMARY OF THE INVENTION

A scope of the invention provides a rear projection display system capable of projecting by use of the combination of micro-projectors.

Another scope of the invention provides a rear projection display system with thin-sized characteristic and high resolution.

According to a preferred embodiment, a rear projection display system of the invention includes a casing, a screen, a processing module, a plurality of micro-projectors, and a plurality of reflectors. The screen is mounted on the casing to form a space. The processing module is disposed in the space. The micro-projectors are disposed in the space, arranged in a form of an array, and respectively electrically connected to the processing module. Each of the reflectors corresponds to one of the micro-projectors. Each of the reflectors is disposed so as to reflect a sub-image projected by the corresponding micro-projector onto the screen.

The processing module is used to receive an input image. The micro-projectors are controlled by the processing module to project an array of overlapped sub-images onto the screen. The sub-images are generated according to the input image. The processing module corrects misalignment of the overlapped sub-images to be projected and further synthesizes the overlapped sub-images as the input image onto the screen by use of the micro-projectors.

Therefore, the projection distance can be substantially shortened by use of a plurality of micro-projectors, so as to achieve the thinner purpose and to further improve the projection resolution.

The advantage and spirit of the invention may be further understood by the following recitations together with the appended drawings.

### BRIEF DESCRIPTION OF THE APPENDED DRAWINGS

FIG. 1A is a sketch diagram illustrating a conventional rear projection display system.

FIG. 1B is a sketch diagram illustrating a currently used rear projection display system.

FIG. 2 is a sketch diagram illustrating a rear projection display system of a preferred embodiment according to the invention.

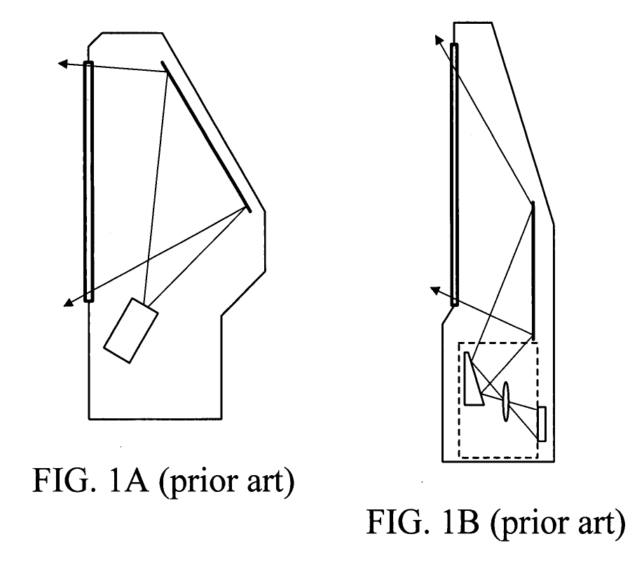

### DETAILED DESCRIPTION OF THE INVENTION

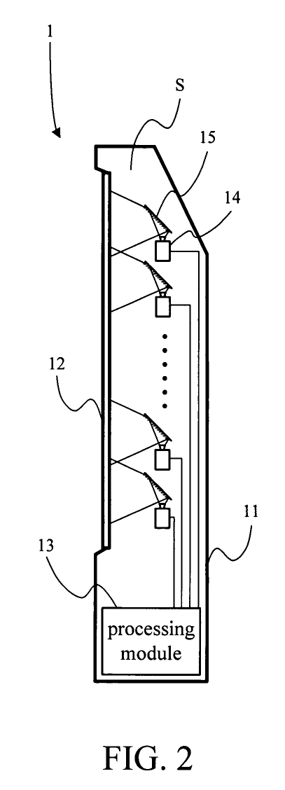

Please refer to FIG. 2. FIG. 2 is a sketch diagram illustrating a rear projection display system 1 of a preferred embodiment according to the invention. The rear projection display system 1 includes a casing 11, a screen 12, a processing module 13, a plurality of micro-projectors 14, and a plurality of reflectors 15. The screen 12 is mounted on the casing 11 to form a space S. The processing module 13 is disposed in the space S. The micro-projectors 14 are disposed in the space S, arranged in a form of an array, and respectively electrically connected to the processing module 13. Each of the reflectors 15 corresponds to one of the micro-projectors 14. Each of the reflectors 15 is disposed so as to reflect a sub-image projected by the corresponding micro-projector onto the screen 12. The micro-projectors 14 are miniature projectors, which has the properties of small volume and short projection distance, such as “handheld device with micro-projection system” of Taiwan invention patent application no. 232995, or other projectors with the above properties. The reflectors 15 can be flat mirrors or other devices providing reflection.

Furthermore, the processing module 13 is used to receive an input image. The micro-projectors 14 are controlled by the processing module 13 to project an array of overlapped sub-images onto the screen 12. The overlapped sub-images are generated according to the input image. The processing module 13 corrects misalignment of the overlapped sub-images to be projected and further synthesizes the overlapped sub-images as the input image onto the screen 12 by use of the micro-projectors 14.

Because the input image is divided by the processing module 13 into the sub-images respectively allocated to each of the micro-projectors 14 which handles only the projection for the corresponding sub-image, the processing module 13 includes a synchronous control circuit for controlling the micro-projectors 14 to synchronously synthesize the overlapped sub-images as the input image to be projected onto the screen 12. Furthermore, in order to obtain a seamless image projected by the micro-projectors 14, the sub-images overlap partially. Therefore, by use of a mosaic technique, the processing module 13 corrects the misalignment of the overlapped sub-images to synthesize a seamless input image which is then synchronously projected onto the screen 12. The mosaic technique can be that cited in “super-resolution display” of U.S. Pat. No. 6,456,339, or other techniques capable of processing overlapped sub-images to be a seamless image. Moreover, the rear projection display system 1 uses the micro-projectors 14 arranged in a form of the array, so the projection size thereof can be flexibly arranged, or even the rear projection display system 1 can perform projecting, together with other projectors.

Obviously, according to the preferred embodiment, the projection distance of the rear projection display system 1 can be substantially shortened by use of the micro-projectors 14 and the reflectors 15, so as to achieve the thinner purpose. Moreover, because each of the micro-projectors 14 only projects one part of the input image, the whole projection resolution of the rear projection display system 1 is better than that of a single projector and the rear projection display system 1 can further provide projection images with high resolution.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A rear projection display system, comprising:
a casing;
a screen mounted on the casing to form a space;
a processing module disposed in the space for receiving an input image; and
a plurality of micro-projectors disposed in the space and arranged in a form of an array, the micro-projectors respectively being electrically connected to the processing module, the micro-projectors being controlled by the processing module to project an array of overlapped sub-images onto the screen, the overlapped sub-images being generated according to the input image, wherein the processing module corrects misalignment of the overlapped sub-images to be projected and further synthesizes the overlapped sub-images as the input image onto the screen by use of the micro-projectors.

2. The rear projection display system of claim 1, further comprising a plurality of reflectors, each of the reflectors corresponding to one of the micro-projectors, each of the reflectors being disposed so as to reflect the sub-image projected by the corresponding micro-projector onto the screen.
